(19) United States
(12) Patent Application Publication
(10) Pub. No.: US 2001/0056484 A1
(43) Pub. Date: Dec. 27, 2001

(54) System, method and control unit for generating a message as e-mail via Internet and/or intranet

(76) Inventor: Werner Blumenstock, Weisendorf (DE)

Correspondence Address: SUGHRUE, MION, ZINN, MACPEAK & SEAS, PLLC, 2100 PENNSYLVANIA AVENUE, N.W., WASHINGTON, DC, 20037-3213, US

(21) Appl. No.: 09/785,237

(22) Filed: Feb. 20, 2001

Related U.S. Application Data
(63) Continuation of application No. PCT/DE99/02467, filed on Aug. 6, 1999.

(30) Foreign Application Priority Data
Aug. 19, 1998 (DE) 19837650.2

(51) Int. Cl. G06F 15/16; G06F 15/173

(52) U.S. Cl. 709/224; 709/206

(57) ABSTRACT

A system, method and control unit for generating a message, particularly an alarm message of a control unit of an automation system. Simplified use of existing transmission means is proposed for transmitting the message of a control unit as an e-mail message via an Intranet and/or the Internet to a predetermined receiving device. In accordance with the invention, the control unit enters a message identification individually assigned to each message in an identification field of the message. The receiving device after receipt of a message returns an acknowledgment to the control unit, which contains the identification associated with the underlying message as the acknowledgment identification. By comparing the acknowledgment identification contained in the acknowledgment with the message identification contained in the transmitted message, the acknowledgment can be uniquely assigned to the transmitted message.

This is a Continuation of International Application PCT/DE99/02467, with an international filing date of Aug. 6, 1999, the disclosure of which is incorporated into this application by reference.

### FIELD OF AND BACKGROUND OF THE INVENTION

The invention generally relates to a system operable to generate messages for a control unit. In particular, the invention is directed to a system operable to generate and transmit an alarm message of a control unit of an automation system and further operable to receive and record acknowledgements for the transmitted alarm messages.

The invention further relates to a control unit, particularly a stored-program control, numeric control and/or robot control unit of an automation system and a method for generating and transmitting a message of a control unit, particularly an alarm message of a control unit of an automation system, and receiving and recording acknowledgements for the alarm messages.

In the field of automation technology, alarm messages are typically displayed in operating and monitoring systems. Such operating and monitoring systems are typically linked to a control unit through a local area network or a fixed or switched line.

### OBJECTS OF THE INVENTION

An object of the present invention is to provide a system, a control unit and a method for generating a message in a simple manner, sending the messages both to on-site and to remote recipients, and receiving responses from the recipients of the messages relative to the messages.

### SUMMARY OF THE INVENTION

The above-mentioned objects of the invention are achieved by providing a system for generating a control unit message, particularly an alarm message for a control unit of an automation system, and transmitting the message, via a data transmission system, to a receiving device that can be linked to the data system. The transmitted message can take the form of an e-mail message, or any other type of communication message, and the data transmission system can be, among other things, an Intranet network and/or the Internet. A control unit in accordance with the invention comprises means for generating the message and sending it, via the data transmission system, to a receiving device with a predefined address. The message may contain an address field to identify an intended recipient of the corresponding message, and the receiving device can have means for receiving the message sent by the control unit.

The above objects are further achieved by providing a control unit, particularly a stored-program control, numerical control and/or robot control unit of an automation system, with a transmitting device operable to generate and transmit a message, particularly an alarm or fault message of the automation system, via a data transmission system, and transmit the message to a receiving device linked to the data system. The transmitting device may have means for generating the message in the form of an e-mail message to the data transmission system embodied as an Intranet and/or the Internet. The message may have an address field to identify an intended recipient of the corresponding message.

Further, the above objects of the present invention are achieved by providing a method for generating a control unit message, particularly an alarm message of a control unit of an automation system, and sending the message, via a data system, to a receiving device linked to the data system in which the message is transmitted, for example, as an e-mail message via an Intranet and/or the Internet, to a predetermined receiving device, for example, a device belonging to or monitored by personnel responsible for addressing the particular alarm message.

An embodiment in accordance with the invention includes utilizing techniques known in the field of information technology for transmitting and receiving messages in the field of automation technology. In accordance with this embodiment, the control unit, e.g. a stored-program control, numerical control, or robot control unit, is provided with corresponding means that enables the control unit to generate e-mail messages. Generally, one or a plurality of desired addressees who are intended to receive the fault or alarm message in the event of a malfunction related to the automation system are predefined in the control unit. The message is transmitted via the infrastructure of an Intranet, i.e. an in-house data network or, for more remote recipients, via the Internet, which allows for communication with any computer connected to the Internet throughout the world. To generate and transmit the messages, standard, existing programs and transmission structures can, thus, be used without any additional costs being incurred. The user, for instance the operator of the automation system or the personnel responsible for monitoring the system, can view the alarms and messages with the existing standard e-mail tools. This obviates the necessity of providing special equipment, specifically dedicated to handling such tools.

A simple and unique assignment of the message to the reporting control unit and to the content of the corresponding message is made possible in that the message has an identification field into which a message identifier, individually assigned to each message, is inserted. The control unit also has means to receive an acknowledgment returned by the receiving device. The acknowledgement contains the identification associated with the underlying message as an acknowledgment identification, and the control unit has means to compare the identification contained in the acknowledgment with the identification contained in the transmitted message.

Intelligent administration and recordation of the messages within the control unit itself is ensured in that the control unit has means for marking a message, i.e., an alarm message, as acknowledged if the control unit receives an acknowledgment with the same message identification that was assigned to the associated transmitted message. Particularly suitable applications, which typically utilize already existing transmission infrastructure, such as e-mail systems, paging systems, etc., are those in which the control unit is a stored-program control, numerical control and/or robot control unit.

Within a control unit, capable of automatically generating messages in accordance with the invention, there is provided means to receive an acknowledgment returned by the receiving device, where the acknowledgement contains the identification associated with the underlying message as the acknowledgement identification, and means to compare the identification contained in the acknowledgment with the identification contained in the transmitted message. The originally transmitted message and the acknowledgment each have an identification field containing either a message identification or acknowledgment identification individually assigned to each message. Further, by using tools such as e-mail, the recipient acknowledging the received message can automatically reply to the message, i.e., acknowledge, by pressing a button, or performing some other equally simple task. The recipient need not make voice communication with the control unit, or its monitoring personnel, in order to respond to the message. Provisions can be provided within the recipient's e-mail, or the other tools used, to automatically provide identification information within the acknowledgment.

A unique assignment of the message and the control unit, or a unique identification of the message, is achieved in that the control unit provides a message identification individually assigned to each message in an identification field of the message. The receiving device, after receipt of a message, returns an acknowledgment to the control unit. As mentioned above, the acknowledgement contains the identification associated with the underlying message as the acknowledgment identification. The control unit then compares the acknowledgment identification contained in the acknowledgment with the message identification contained in the transmitted message.

Automatic recordation with respect to messages transmitted to and messages received from the corresponding addressees is made possible in that receipt of a message is confirmed in the control unit when the control unit receives an acknowledgment with the message identification assigned to the associated message.

### BRIEF DESCRIPTION OF THE DRAWINGS

The invention and further advantageous refinements of the invention according to the features of the dependent claims are explained in more detail below with the aid of diagrammatic, exemplary embodiments in the drawings, in which:

FIG. 1 is a block diagram of an exemplary embodiment of a system to generate an alarm message,

FIG. 2a is an exemplary embodiment of the basic structure of a display of an alarm message,

FIG. 2b is an exemplary embodiment of the basic structure of an acknowledgment, and

FIG. 3 is a flowchart representation of the process sequence for generating and acknowledging a message.

### DETAILED DESCRIPTION OF THE PREFERRED EMBODIMENTS

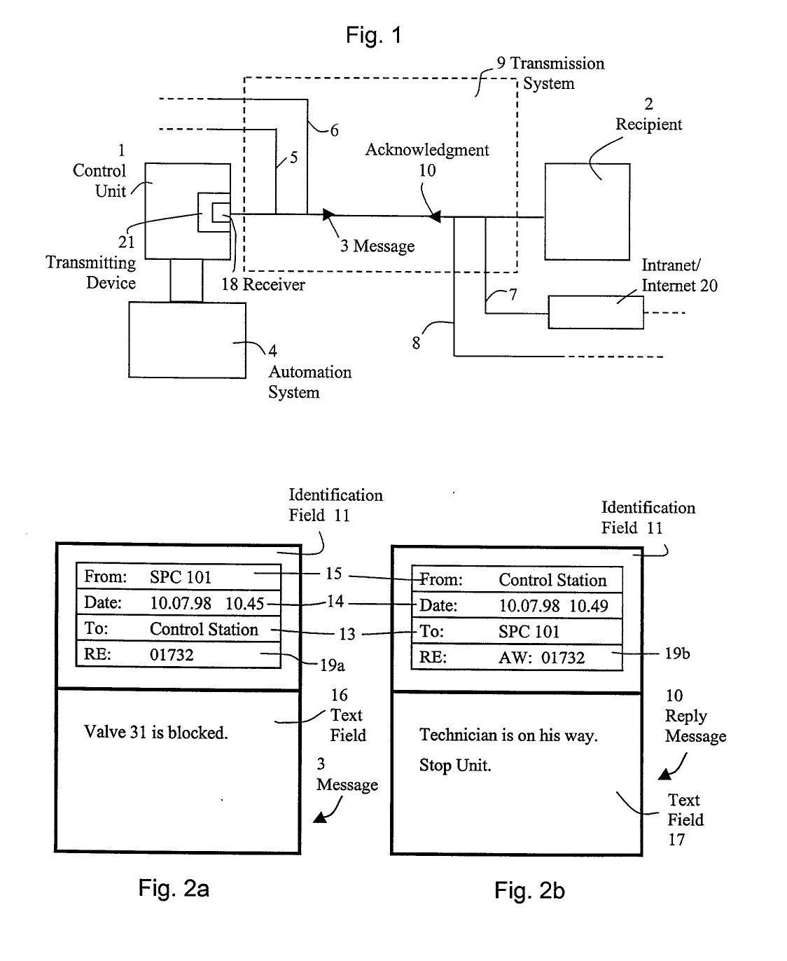

FIG. 1 shows an exemplary embodiment of a system operable to generate an alarm message in accordance with the present invention. The system comprises a control unit 1 coupled to an automation system 4. Control unit 1 is, for example, a stored-program control unit, numerical control unit or, a robot control unit. Control unit 1 has a transmitting device 21 operable to generate a message 3, for example, in the form of an e-mail message. Message 3 is transmitted via a transmission system 9 to a recipient 2. Recipient 2 can be any device capable of receiving transmitted message 3. For example, recipient 2 can be a computer (wireless or wireline), a cell-phone, a pager, or any other similar device. Also, recipient 2 has means for acknowledging the message 3 through generation of an acknowledgment 10.

The transmission system 9 has branches 5, 6, 7, 8. These branches 5, 6, 7, 8 are connected, for example, with other control units, operation and observation systems, etc. Through a connection with line 7, the data transmission system 9 is linked to the World Wide Web (i.e., the Internet). For example, the transmission system may comprise a data processing unit acting as a server with access to the Internet.

One unique feature of the system shown in FIG. 1 is that the control unit 1 comprises transmitting device 21, which accesses a communication infrastructure in the form of a data transmission system 9, which is typically preexisting within a company or other user employing a system in accordance with the invention. The transmitting and/or receiving device 21/18 works in conjunction with standard e-mail or similar message tools, such as Microsoft Exchange, etc.

In the event of a fault within the automation system, or even a desired alarm message 3 where no problems are necessarily detected, the e-mail tool is activated in the control unit. The designated recipient of message 3 is, for instance, the receiving device 2. Moreover, any recipient capable of being addressed through the data transmission system 9, i.e. by Intranet connections 5, 6, 8 or Internet connection 7, can be indicated in the transmitted message 3. However, in a typical use of the system of the invention, the recipient of message 3 is usually personnel responsible for fixing the problem associated with the message or for simply performing certain tasks in response to the message.

In the reference field of message 3, a unique identification or a keyword, such as “alarm” is entered, which individually characterizes and identifies message 3. In the text portion of message 3, the corresponding alarm or message text is entered. When completed, message 3 is sent to recipient 2 and possibly to other recipients as well. Recipient 2 can use the reply function of the employed e-mail tool to automatically send a reply to control unit 1. Advantageously, the identification contained in the reference field of message 3 is transferred to the reference field of the reply message 10. This reply message 10, or acknowledgment 10, is sent to the control unit 1 and is received by transmitting/receiving device 21/18. By utilizing the identification contained in the reference field of the acknowledgment 10, the reply message 10 can be automatically assigned to the associated alarm, or associated message 3. Within the control unit 1, the status of message 3 is then changed to “acknowledged.” The alarm and message system shown in FIG. 1 permits simple and reliable transmission of alarm messages, etc. By using a typical preexisting infrastructure, such as an Intranet and/or the Internet, constructing a self-contained communications infrastructure for transmitting alarms or messages is avoided. This provides significant cost savings. For example, no specialized e-mail tools need be provided and, further, the recipient(s) of the messages need not necessarily go out of their way to acknowledge the message, they can simply activate the automatic reply feature existing within the e-mail system to acknowledge the message.

FIG. 2a shows an example of the basic structure of an alarm message 3, such as it can be displayed in accordance with an embodiment of the invention, for instance, on a screen by means of the control unit and/or the receiving device 2 of FIG. 1. Message 3 has an identification field 11 and a text field 16. The identification field 11 comprises an address field 13, a sender field 15, a reference field 12 and a date and time field 14 to indicate the transmission date and time of the message 3, which as a rule is automatically assigned by the e-mail server. The address field 13 indicates the address of the recipient(s) 2, delivery to which the message 3 is intended. The sender field 15 indicates the sender, i.e. the control unit, that issues message 3. The transmission date and time field 14 shows the date and time of the generation of message 3, whereas the reference field 12 carries an identification 19a uniquely assigned to each alarm.

Text field 16 contains any text message. Message text contained in text field 16 can be any text that is desired to accompany the message and can be either automatically generated and input by the control unit or it can be manually entered by a user. One example of where the control unit might enter the text message automatically is where the control unit utilizes specialized software to determine the nature of the event which caused the generation of the message. Under this situation, the control unit can then derive a text message indicating the circumstances surrounding the message and place the text message in the text field.

The structure of message 3 depicted in FIG. 2a may correspond to the familiar structure of known e-mail tools, such as Microsoft Exchange. This known structure is adapted to the special tasks of issuing a fault or alarm message in that the e-mail message is automatically generated and the individual entries in address field 13, sender field 15 and reference field 12 are automatically generated when message 3 is generated.

FIG. 2b shows the basic structure of an acknowledgment, or Reply Message, 10 in accordance with the present invention. The basic structure of the acknowledgement 10 corresponds to that of message 3, as shown in FIG. 2a. Acknowledgment 10, similar to the message 3, has an identification field 11 and a text field 17. The address field 13 of acknowledgment 10 contains the addressee “SPC Stored Program Controller 101” contained in message 3, whereas the sender field 15 contains the sender identification, in this case “Control Center.” Reference field 12 contains an acknowledgment identification 19b, which corresponds to, and is transferred from, the message identification 19a of message 3. Text field 17 in the example shown in FIG. 2b contains reply text which can be automatically input via recipient's predefined rules, or it can be manually input via the recipient. The reply text may further include control commands in a programming language, which are provided to control the control unit 1. For example, within acknowledgment message 10, software commands can be included that, upon receipt by control unit 1, are implemented using a processor or other similar device, to carry out specific actions. The actions implemented by the software commands can, for example, directly address the event which caused the generation of message 3, or they can be directed to carrying out additional functions, such as notifying other recipients, etc.

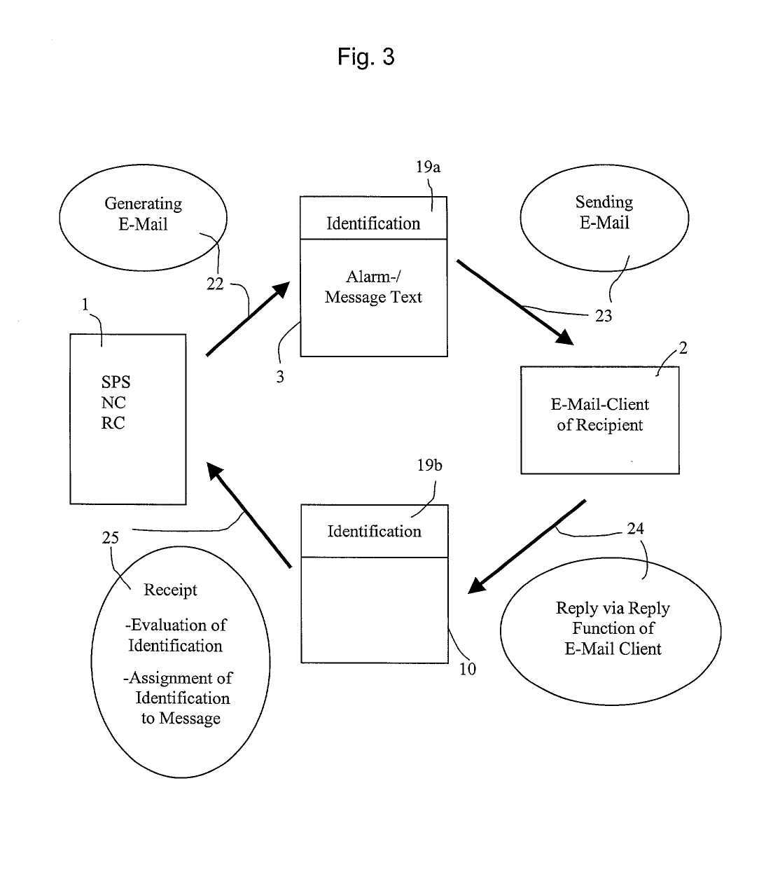

FIG. 3 shows a flowchart representation of the process sequence for generating and acknowledging a message 3 in accordance with the invention. In a process step 22 a control unit 1 generates an e-mail message 3 having, for instance, the structure shown in FIG. 2a. In a second process step 23, the e-mail message 3, thus generated, is sent via an Intranet and/or the Internet to a recipient 2, i.e. to the e-mail client. The e-mail client of recipient 2 in a third process step 24 then uses the reply function to generate an e-mail reply as acknowledgment 10. The structure of acknowledgment 10 corresponds, for example, to the structure shown in FIG. 2b. In a further process step 25, the control unit 1 receives acknowledgment 10, evaluates it, and by means of identifications 19a, and 19b, included therein, assigns it to message 3.

In summary, the invention relates to a system, a method and a control unit for generating a message, particularly an alarm message of a control unit 1 of an automation system 4. Simplified use of existing transmission means is proposed such that message 3 of a control unit 1 is transmitted as an e-mail message via an Intranet and/or the Internet 20 to a predetermined receiving device 2. In an advantageous embodiment, control unit 1 enters a message identification 19a individually assigned to each message 3 in an identification field 12 of message 3. After receipt of message 3, the receiving device 2 sends an acknowledgment 10 to control unit 1, which includes identification 19a associated with the underlying message 3 as acknowledgment identification 19b. By comparing the acknowledgment identification 19b contained in acknowledgment 10 with the message identification 19a contained in the transmitted message 3, acknowledgment 10 can be uniquely assigned to the transmitted message.

The above description of the preferred embodiments has been given by way of example. From the disclosure given, those skilled in the art will not only understand the present invention and its attendant advantages, but will also find apparent various changes and modifications to the structures disclosed. It is sought, therefore, to cover all such changes and modifications as fall within the spirit and scope of the invention, as defined by the appended claims, and equivalents thereof.

What is claimed is:

1. A system operable to generate a message related to a control unit of an automation system, the system comprising:
a data transmission system in communication with the control unit and in further communication with a receiving device,
wherein the message is an e-mail message and the data transmission system is an Intranet and/or the Internet and the control unit comprises means for generating the message for a specific receiving device addressable with a pre-defined address and, wherein further the message has an address field to identify a recipient of the corresponding message, and the receiving device has means to receive the message sent by the control unit and automatically respond to the message.

2. The system as claimed in claim 1, wherein the message has an identification field for inserting a message identification that is individually assigned to each message and the control unit comprises means to receive an acknowledgment returned by the receiving device which is intended for the control unit, said acknowledgment comprising the identification associated with the message as an acknowledgment identification, and the control unit further comprising means to compare the acknowledgment identification contained in acknowledgment with the message identification contained in the transmitted message.

3. A system as claimed in claim 2, wherein the control unit further comprises means for marking the message as acknowledged if the means to compare determines that the control unit has received an acknowledgment with the message identification assigned to the associated transmitted message.

4. A system as claimed in claim 1, wherein the control unit is a stored-program control unit.

5. A control unit of an automation system comprising a transmitting device operable to generate and transmit an alarm or fault message of the automation system, via a data transmission system, to a receiving device capable of being linked to said data transmission system, wherein the transmitting device comprises means to generate the message as an e-mail message directed through the data transmission system embodied as an Intranet and/or the Internet, wherein the message comprises an address field to identify a recipient of the corresponding message.

6. A control unit as claimed in claim 5, wherein said control unit is a stored-program control unit.

7. A control unit as claimed in claim 5, wherein the message comprises an identification field for a message identification individually assigned to each message, the control unit further comprising;
means to receive an acknowledgment returned by the receiving device to the control unit, said acknowledgment comprising the identification associated with the underlying message as the acknowledgment identification, and
means to compare the identification contained in the acknowledgment with the identification contained in the transmitted message.

8. A method for producing a message of a control unit of an automation system, the method comprising:
sending the message via a data system to a receiving device capable of being linked to the data system, wherein the message is an e-mail message transmitted via an Intranet and/or the Internet to a predetermined receiving device.

9. The method as claimed in claim 8, wherein the control unit enters a message identification individually assigned to each message into an identification field of the message and the receiving device, after receipt of a message, automatically generates and returns an acknowledgment to the control unit, wherein said acknowledgment contains the identification associated with the underlying message as the acknowledgment identification, and the control unit compares the acknowledgment identification contained in the acknowledgment with the message identification contained in the transmitted message.

10. The method as claimed in claim 7, wherein receipt of a message is confirmed in the control unit if the control unit received an acknowledgment with the message identification assigned to the associated message.

11. The method as claimed in claim 7, wherein the method is used to generate a fault and/or alarm message of a stored-program control unit, a numerical control unit and/or a robot control unit in connection with an automation system.

12. A system operable to generate a message related to a control unit, said system comprising:
an automation system operable to perform automated functions;
a control unit connected to the automation system operable to detect a fault condition in said automation system and automatically generate a message in response to said detected fault condition;
a data transmission system operable to receive the message from the control unit and transmit the message to one or more recipients, wherein said recipients acknowledge receipt of said message.

13. A system operable to generate a message related to a control unit, said system comprising:
an automation system operable to perform automated functions;
a control unit connected to the automation system, said control unit comprising,
a fault detector operable to detect a fault condition in said automation system;
a message generator operable to generate a message in response to said detected fault condition; and
a transmitter device operable to transmit the message; said system further comprising;
a data transmission system connected to the control unit operable to receive the message from the transmitter of the control unit and transfer the message to one or more recipients in the form of an e-mail message, receive acknowledgment from the recipient and transfer the acknowledgment to the control unit; and
a comparator operable to compare a message identification of the message and the acknowledgment of the recipient.

14. A system in accordance with claim 13, wherein said message is automatically generated as an e-mail message upon detection of said fault condition, and immediately sent to one or more recipients with predefined addresses.

15. A system in accordance with claim 13, wherein said acknowledgment comprises:
a sender identification field containing an identification of the recipient from which the acknowledgment was generated;
a date and time field containing information regarding the date and time that the acknowledgment was created;
an addressee identification field containing identification of the intended control unit;
a reference field containing a specific identification for a message to which said acknowledgment corresponds; and
a text field containing text related to a remedial action.

16. A system in accordance with claim 13, wherein said message comprises:
a sender identification field containing an identification of the control unit from which the message was generated;
a date and time field containing information regarding the date and time that the message was created;
a recipient identification field containing identification of the intended recipient;
a reference field containing a specific identification for the message; and
a text field containing text related to said fault condition.

17. A control unit operatively connected to an automation system and a data transmission system, said control unit comprising:
a fault detector operable to detect a fault in said automation system;
a message generator operable to automatically generate a fault message indicative of said fault, wherein said fault message comprises at least a message identification specifically identifying the message;
a transmission device operable to transmit the fault message via the transmission system to one or more recipients, wherein the recipients are specifically addressed to receive the message; and
a receiving device operable to receive an acknowledgement generated by said recipient(s), said acknowledgement comprising at least an acknowledgment identification specifically identifying the message which it is acknowledging.

18. A method for generating a notification message in response to an event occurring within an automation system, the method comprising:
detecting the event in the automation system;
automatically generating, in a control unit, the notification message in response to the event;
placing the notification message in a data transmission system and sending the notification message to a predefined recipient;
automatically generating an acknowledgment in response to receipt of said notification;
sending the acknowledgment through the data transmission system to the control unit; and,
recording whether said notification message has been acknowledged.

19. The method according to claim 18, wherein said notification message is an e-mail message.

20. The method according to claim 18, wherein the acknowledgment comprises software commands performed by said control unit.

21. A system as claimed in claim 1, wherein the control unit is a numerical control unit.

22. A system as claimed in claim 1, wherein the control unit is a robot control unit.

23. A control unit as claimed in claim 5, wherein said control unit is a numerical control unit.

24. A control unit as claimed in claim 5, wherein said control unit is a robot control unit.

25. A control unit in accordance with claim 17, further comprising:
an identification comparator operable to compare the message identification and the acknowledgment identification; and
a recordation device operable to record results of the operation of the identification comparator.
